(19) United States
(12) Patent Application Publication
(10) Pub. No.: US 2012/0145736 A1
(43) Pub. Date: Jun. 14, 2012

(54) DISPENSING MECHANISM FOR UTENSIL DISPENSER AND RELATED METHODS

(75) Inventors: Richard S. Walters, Port Washington, WI (US); Morgan J. Lowery, DeForest, WI (US)

(73) Assignee: DIXIE CONSUMER PRODUCTS LLC, Atlanta, GA (US)

(21) Appl. No.: 13/315,331

(22) Filed: Dec. 9, 2011

Related U.S. Application Data
(60) Provisional application No. 61/421,998, filed on Dec. 10, 2010.

(51) Int. Cl. B65G 59/06

(52) U.S. Cl. 221/1; 221/195

(57) ABSTRACT

A dispenser for dispensing cutlery may include a housing configured to contain a plurality of utensils for dispensing, a dispensing mechanism comprising at least one pair of indexing members configured to separate a utensil from a stack of utensils, and a receptacle configured to receive the utensil separated from the stack of utensils. A dispensing mechanism may alternatively include a plurality of linked members configured to separate a utensil from a stack of utensils.

### CROSS-REFERENCE TO RELATED APPLICATION

This application claims priority to U.S. Provisional Patent Application No. 61/421,998 filed Dec. 10, 2010, the disclosure of which is incorporated herein in its entirety by this reference.

### FIELD OF THE INVENTION

The present disclosure relates to dispensing cutlery. In particular, the present disclosure relates to dispensers for dispensing utensils, dispensing mechanisms for dispensing utensils, and related methods.

### BACKGROUND

Disposable cutlery may be provided as a less expensive alternative to reusable cutlery, for example, at restaurants and social gatherings where it is undesirable or cost prohibitive to clean the cutlery for reuse. However, providing disposable cutlery may present a number of potential drawbacks related to the nature in which it is dispensed.

For example, providing disposable cutlery in a loose or unpackaged fashion, such as in loose form in a receptacle containing the disposable cutlery, may result in patrons taking more cutlery than necessary, thereby increasing the cost of providing the cutlery. In addition, providing loose or unpackaged cutlery may present concerns regarding whether dispensing cutlery in such a manner is hygienic. As a result, it may be desirable to dispense disposable cutlery in a manner other than in a loose or unpackaged form.

The above-noted concerns may be addressed by dispensing disposable cutlery from dispensers configured to contain a supply of the cutlery and dispense a disposable utensil upon operation of a patron. However, the complexity and expense of many dispensers may reduce the benefit to the purchaser of the dispenser. Thus, it may be desirable to provide a simple and reliable dispenser in order to further reduce costs and increase efficiency.

In addition, it may be desirable to provide a dispenser that is capable of dispensing utensils without flipping or otherwise altering the orientation of the utensils during the dispensing process. For example, some dispensers may cause utensils to flip or rotate within the dispenser as a stack of the utensils slides within the dispenser, which may lead to jamming the dispenser, thereby potentially compromising its utility.

Additionally, it may be desirable to provide a dispenser capable of reliably dispensing utensils. Dispensers that lack a reliable dispensing mechanism may have a tendency to cause patrons to unintentionally dispense more than one utensil at a time and/or jam the dispenser such that no utensils can be dispensed until the dispenser is manually un-jammed. This may result in compromising one of the potential advantages of dispensing utensils via a dispenser—reducing costs associated with patrons taking more utensils than necessary.

Thus, it is desirable to provide a system and method for addressing one or more of the potential drawbacks discussed above.

### SUMMARY

In the following description, certain aspects and embodiments will become evident. It should be understood that the aspects and embodiments, in their broadest sense, could be practiced without having one or more features of these aspects and embodiments. Thus, it should be understood that these aspects and embodiments are merely exemplary.

One aspect of the disclosure relates to a dispenser for dispensing cutlery. The dispenser may include a housing configured to contain a plurality of utensils for dispensing, a dispensing mechanism that includes at least one pair of indexing members configured to separate a utensil from a stack of utensils, wherein the at least one pair of indexing members comprises rotors configured to separate the utensil from a stack of utensils via rotation of the rotors, and a receptacle configured to receive the utensil separated from the stack of utensils.

Another aspect relates to a dispenser for dispensing cutlery. The dispenser may include a housing configured to contain a plurality of utensils for dispensing, a dispensing mechanism that includes a plurality of linked members configured to separate a utensil from a stack of utensils, and a receptacle configured to receive the utensil separated from the stack of utensils.

Yet another aspect relates to a method for dispensing cutlery from a dispenser. The method may include providing a dispenser for dispensing cutlery, providing a plurality of utensils for dispensing, the utensils adapted to be positioned in within the dispenser, indexing at least two indexing members such that a utensil can be separated from a stack of utensils, the at least two indexing members comprising rotors configured to separate the utensil from a stack of utensils via rotation of the rotors, and providing access to the utensil separated from the stack of utensils.

A further aspect relates to a method for dispensing cutlery from a dispenser. The method may include providing a dispenser for dispensing cutlery, the dispenser including a plurality of linked members, providing a plurality of utensils for dispensing, the utensils adapted to be positioned within the dispenser, manipulating at least one of a plurality of linked members such one of the plurality of utensils is separated from a stack of utensils, and providing access to the utensil separated from the stack of utensils.

### BRIEF DESCRIPTION OF THE DRAWINGS

The accompanying drawings, which are incorporated in and constitute a part of this description, illustrate several embodiments and together with the description, serve to explain principles of the embodiments. In the drawings,

FIG. 1 is a schematic perspective view of an embodiment of a dispenser for dispensing utensils.

FIG. 2A is a schematic partial cross-sectional view along line A-A of FIG. 1 showing a dispensing mechanism in a first condition.

FIG. 2B is a schematic partial cross-sectional view along line A-A of FIG. 1 showing the dispensing mechanism of FIG. 2A in a second condition.

FIG. 3 is a schematic view of an indexing member.

FIG. 4A is a schematic partial cross-sectional view along line A-A of FIG. 1 showing another dispensing mechanism in a first condition.

FIG. 4B is a schematic partial cross-sectional view along line A-A of FIG. 1 showing the dispensing mechanism of FIG. 4A in a second condition.

### DETAILED DESCRIPTION OF EMBODIMENTS

Reference will now be made in detail to various embodiments. Wherever possible, the same reference numbers are used in the drawings and the description to refer to the same or like parts.

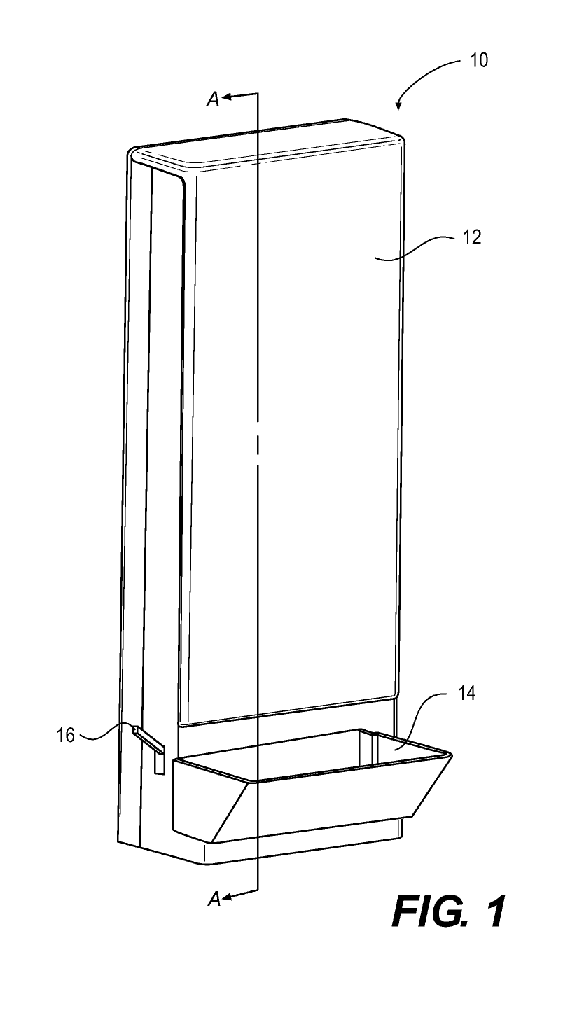

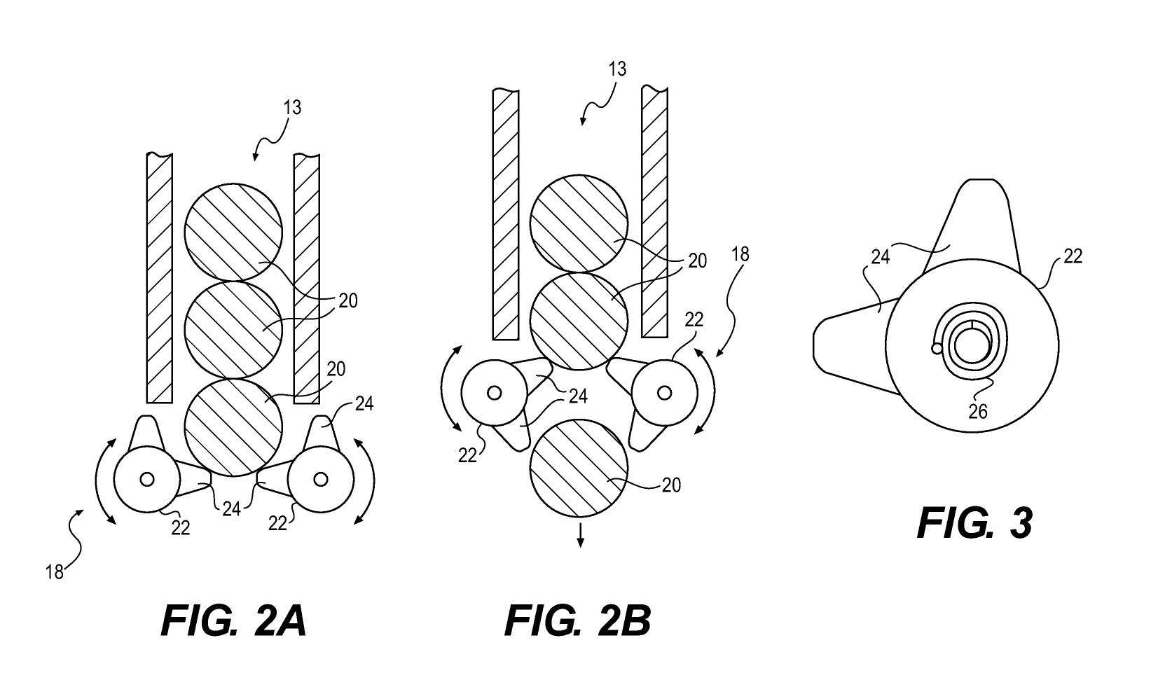

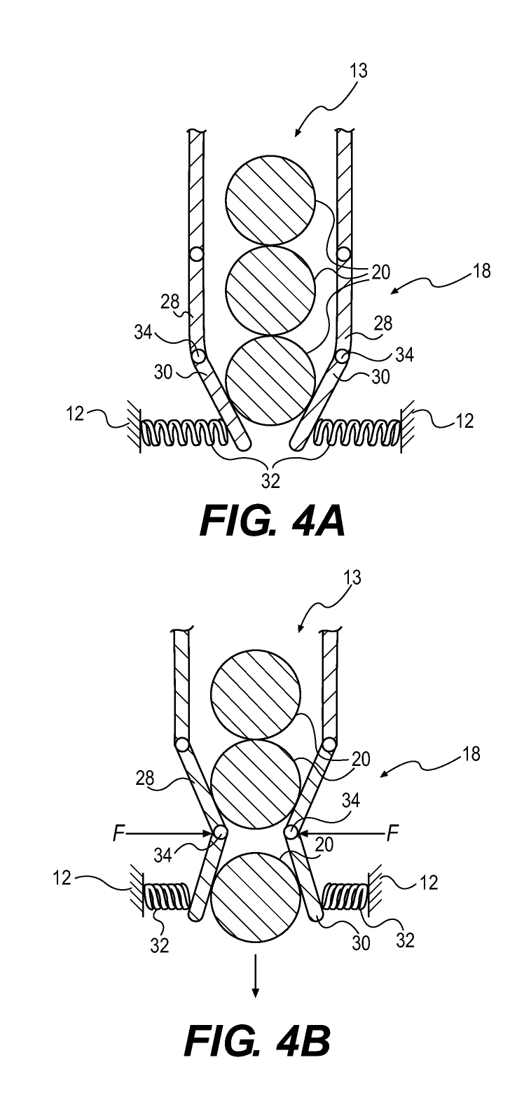

FIG. 1 shows a schematic perspective view of a dispenser 10 for dispensing utensils. Dispenser 10 includes a housing 12 configured to store a plurality of utensils 20 (see FIGS. 2A, 2B, 4A, and 4B). Housing 12 may be configured to receive utensils 20 in various arrangements. Housing 12 may be configured to receive one or more of loose utensils, cartridges containing utensils, stacks of utensils bound by a wrapper, and/or stacks of utensils removably coupled to one another. For example, housing 12 may include a chute 13 configured to receive a plurality of utensils 20 in a stack. Chute 13 of housing 12 may feed a dispensing mechanism 18 (see, e.g., FIGS. 2A, 2B, 4A, and 4B), which is configured to dispense at least one utensil 20, for example, individually.

Dispenser 10 includes a receptacle 14 configured to receive utensils 20 dispensed from housing 12 by a dispensing mechanism 18. Dispensing mechanism 18 may be located inside dispenser 10. In some embodiments, dispensing mechanism 18 is located inside housing 12. Dispenser 10 may include an actuator 16 for operation of dispenser 10 by a user. Actuator 16 may be configured to activate dispensing mechanism 18 in order to dispense a utensil 20 from a stack of utensils in chute 13. While FIG. 1 shows actuator 16 in the form of a handle, actuator 16 may be provided in any suitable form, for example, a rotatable knob, a button, a switch, a bar, an electronic sensor (e.g., a proximity sensor), and/or a crank. Additionally, according to some embodiments, actuator 16 may be incorporated into other aspects of dispenser 10. For example, actuator 16 may be incorporated into receptacle 14, such that a user may activate actuator 16 by manipulating receptacle 14 directly in order to operate dispensing mechanism 18. In some embodiments, actuator 16 may be incorporated into other aspects of dispenser 10, such as, for example, housing 12.

FIG. 2A shows a schematic partial cross-sectional view along line A-A of FIG. 1. Specifically, FIG. 2A shows a cross-sectional view of dispensing mechanism 18 and a portion of a stack of utensils 20 in chute 13 in a first condition in which dispensing is not in progress. Utensils 20 are shown with a round cross-sectional shape; however, it is anticipated that utensils 20 may have any cross-sectional shape, including rectangular, square, triangular, and/or other variations common for disposable cutlery. In some embodiments, utensils 20 may have variable cross-sectional shapes, such that, for example, the portion of utensil 20 that is anticipated to contact dispensing mechanism 18 may be shaped to facilitate dispensing (e.g., it may have a handle portion that is generally rectangular in cross-section with rounded edges), while other portions of utensil 20 may have different cross-sectional shapes. According to some embodiments, utensils 20 may be any type of utensil, including, for example, at least one of a spoon, a fork, a knife, and a spork. Utensils 20 may be constructed from a formable material. The formable material may include, for example, plastic, combinations of plastics, or combinations of plastics and other materials suitable for use as disposable or reusable cutlery. For example, the formable material may include one or more of polystyrene, polyethylene, and polypropylene.

According to some embodiments, dispensing mechanism 18 may facilitate the dispensing of utensils 20 from a stack of utensils. In particular, dispensing mechanism 18 may be configured to retain a plurality of utensils 20 inside housing 12 until a user operates actuator 16 of dispenser 10. During operation, dispensing mechanism 18 may separate at least one utensil 20 from a stack of utensils and allow the at least one utensil 20 to proceed, for example, via gravity, from chute 13 to receptacle 14, where it may be received by a user. In some embodiments, dispensing mechanism 18 may be operated via actuator 16. For example, a user may operate actuator 16 in a downward direction in order to operate dispensing mechanism 18 and dispense utensil 20. The method of operating actuator 16 in order to operate dispensing mechanism 18 may depend on the form of actuator 16, which may be provided in any suitable form, for example, a rotatable knob, a button, a switch, a bar, an electronic sensor, and/or a crank.

FIG. 2A shows dispensing mechanism 18, including at least one pair of indexing members 22. While FIG. 2A shows one pair of indexing members 22, any number of indexing members 22 may be utilized by dispensing mechanism 18 including a single indexing member 22. In some embodiments, each indexing member 22 comprises at least one rotatable rotor and at least one indexing protrusion 24. For example, FIG. 2A shows a pair of indexing members 22 that each comprise two indexing protrusions 24 disposed on rotatable rotors. In some embodiments, indexing members 22 may each include any number of indexing protrusions 24, for example, 3, 4, 5, or more, indexing protrusions 24. Indexing members 22 may be configured to have an initial orientation that retains utensils 20 within chute 13. According to some embodiments, at least one indexing protrusion 24 comes into contact with a utensil 20 positioned to be dispensed first (e.g., a utensil 20 at the bottom of the stack of utensils in chute 13). For example, FIG. 2A shows a pair of indexing members 22 positioned such that one utensil 20 rests on indexing protrusions 24.

According to some embodiments, indexing members 22 may be configured to index in a manner that separates one utensil 20 from the stack of utensils. For example, FIG. 2A shows indexing members 22 configured to rotate at least an amount sufficient to release utensil 20 from the stack of utensils in chute 13. The amount of rotation necessary to release utensil 20 may depend on the size and shape of utensil 20, the size and shape of indexing members 22, the location of indexing members 22 relative to each other and to utensils 20, and/or the configuration and/or number of indexing protrusions 24.

FIG. 2B shows a similar schematic partial cross-sectional view along line A-A of FIG. 1 in a second condition in which utensil 20 is being dispensed. In the embodiment shown in FIG. 2B, indexing members 22 are capable of rotatably separating a utensil 20 from a stack of utensils. FIG. 2B shows the embodiment of FIG. 2A after a partial rotation of indexing members 22. The rotation of indexing members 22 may orient indexing protrusions 24 such that one utensil 20 is separated from a stack of utensils and dispensed into receptacle 14. According to some embodiments, each indexing member 22 comprises more than one indexing protrusion 24 in order to separate one utensil 20 while simultaneously retaining the remaining utensils 20 in a stack in chute 13. For example, FIG. 2B shows a second set of indexing protrusions 24 contacting and retaining a stack of utensils in chute 13 while one utensil 20 has been released for dispensing.

After dispensing utensil 20, indexing members 22 may be configured to either return to a pre-dispensing orientation or assume a post-dispensing orientation. For example, in some embodiments indexing members 22 may rotate in one direction from an initial orientation to separate and dispense utensil 20 from the stack of utensils, and thereafter rotate in the opposite direction to return to the initial, pre-dispensing orientation. On the other hand, according to some embodiments, indexing members 22 may rotate in one direction to separate and dispense utensil 20 from the stack of utensils, and either remain in that orientation or rotate further in the same direction in order to reach a post-dispensing orientation distinct from the pre-dispensing orientation.

As shown in FIG. 3, some embodiments of indexing members 22 may return to a pre-dispensing orientation via counter-rotation influenced by indexing springs 26. In some embodiments, for example, indexing spring 26 may comprise a spring attached at one end to indexing member 22 and attached at the other end to a static point associated with dispenser 10. It is contemplated that indexing spring 26 may be any type of spring suitable for returning indexing member 22 to its pre-dispensing orientation, for example, a coil spring, cantilever spring, torsion spring, tension spring, or the like.

In the embodiment shown in FIG. 3, an indexing spring 26 is located on the face of indexing member 22. In some embodiments, as indexing member 22 rotates from a pre-dispensing position, indexing spring 26 may apply a counter-rotational force. In particular, indexing spring 26 may apply a force sufficient to return indexing member 22 to its pre-dispensing position after a user terminates operation of actuator 16.

FIG. 4A shows a schematic partial cross-sectional view of another embodiment of dispensing mechanism 18 along line A-A of FIG. 1, in a first condition in which dispensing is not in progress. Dispensing mechanism 18 includes a plurality of rotatably-linked members 28 and 30 configured to separate a utensil 20 from a stack of utensils in chute 13. While FIG. 4A shows a plurality of linked members 28 and 30 on each side of utensil 20, any number of pluralities of linked members 28 and 30 may be utilized by dispensing mechanism 18 including a single plurality of linked members 28 and 30. As shown in FIG. 4A, rotatably-linked members 28 and 30 may include at least one pair of first rotatably-linked members 28 and at least one pair of second rotatably-linked members 30. According to some embodiments, first rotatably-linked members 28 and second rotatably-linked members 30 may be connected via at least one joint or pin 34. Joint 34 may be configured to allow for substantially free rotational movement in at least one direction. In some embodiments, rotatably-linked members 28 and 30 may be configured such that the stack of utensils is retained within dispensing mechanism 18, housing 12, and/or chute 13 until a user activates actuator 16 of dispenser 10.

While any number of configurations may be used to retain utensils 20 in chute 13, FIG. 4A shows a pair of resistance springs 32 in contact with second rotatably-linked members 30. According to some embodiments, resistance springs 32 contact second rotatably-linked members 30 closer to the end of members 30 opposite first rotatably-linked members 28. Resistance springs 32 may apply force to second rotatably-linked members 30 such that, while a user is not operating dispenser 10, the distance between second rotatably-linked members 30 is shortest between the ends of members 30 opposite first rotatably-linked members 28 (e.g., FIG. 4A). In such an embodiment, second rotatably-linked members 30 apply a retaining force to utensil 20 such that utensil 20 remains in the stack of utensils in chute 13.

FIG. 4B shows dispensing mechanism 18 in a second condition in which utensil 20 is being dispensed. As shown in FIG. 4B, a pair of dispensing forces F may be applied to joints 34 such that a utensil 20 is separated from the stack of utensils and dispensed. For example, dispensing forces F may be applied by a user's activation of actuator 16, which transfers force, either directly or indirectly, to one or more joints 34. Alternatively, dispensing forces F may be generated in response to another mechanism. In some embodiments, dispensing forces F may be applied in one or more areas other than joints 34. Additionally, in some embodiments, only one dispensing force F is applied to rotatably-linked members 28 and 30.

In the embodiment shown in FIGS. 4A and 4B, dispensing forces F cause a pinching effect, decreasing the distance between joints 34 and counteracting resistance springs 32. The pinching effect may apply one of either a separating force and a retaining force to at least one utensil 20. In some embodiments, second rotatably-linked members 30 may apply a separating force to one utensil 20 while first rotatably-linked members 28 may apply a retaining force to the remaining, un-dispensed utensils 20 of the stack of utensils. According to some embodiments, utensil 20 may be shaped such that, as joints 34 move closer to one another, second rotatably-linked members 30 rotate about utensil 20, which may cause the distance between the ends of the members that are not attached to first rotatably-linked members 28 to increase. Depending on the magnitude of dispensing force F, second rotatably-linked members 30 may move enough to release utensil 20. Dispensing forces F may be more important in the separation of utensils 20 that are coupled together by adhesive or any other securing mechanism.

According to the embodiment shown in FIGS. 4A and 4B, after utensil 20 is dispensed, the user may release or deactivate actuator 16 and thereby reduce or eliminate dispensing force F. In such an example, resistance springs 32 may apply a force to second rotatably-linked members 30 sufficient to return second rotatably-linked members 30 and/or first rotatably-linked members 28 to pre-dispensing positions without dispensing more than one utensil 20.

It will be apparent to those skilled in the art that various modifications and variations can be made to the structures and methodologies described herein. Thus, it should be understood that the invention is not limited to the subject matter discussed in the description. Rather, the present disclosure is intended to cover modifications and variations.

What is claimed is:

1. A dispenser for dispensing cutlery, the dispenser comprising:
a housing configured to contain a plurality of utensils for dispensing;
a dispensing mechanism comprising at least one pair of indexing members configured to separate a utensil from a stack of utensils, wherein the at least one pair of indexing members comprises rotors configured to separate the utensil from a stack of utensils via rotation of the rotors; and
a receptacle configured to receive the utensil separated from the stack of utensils.

2. The dispenser of claim 1, wherein the indexing members are configured to rotate from an initial orientation an amount sufficient to separate a utensil from the stack of utensils, and thereafter return to the initial orientation.

3. The dispenser of claim 1, wherein the dispensing mechanism comprises at least one spring configured to influence the orientation of the indexing members.

4. The dispenser of claim 1, wherein the indexing members are configured to rotate in a single direction by increments sufficient to separate a utensil from the stack of utensils.

5. A dispenser for dispensing cutlery, the dispenser comprising:
a housing configured to contain a plurality of utensils for dispensing;
a dispensing mechanism comprising a plurality of linked members configured to separate a utensil from a stack of utensils; and
a receptacle configured to receive the utensil separated from the stack of utensils.

6. The dispenser of claim 5, wherein at least one of the linked members is configured to provide one of a separating force and a retaining force to at least one utensil.

7. The dispenser of claim 5, wherein the linked members are configured to separate a utensil from a stack of utensils by rotation of at least one of the linked members about a joint coupling one linked member to another linked member.

8. The dispenser of claim 5, wherein the dispensing mechanism comprises at least one spring configured to influence an orientation of the linked members.

9. The dispenser of claim 5, wherein the dispensing mechanism comprises at least one self-biasing joint configured to influence an orientation of the linked members.

10. The dispenser of claim 5, wherein the dispensing mechanism comprises at least two pluralities of linked members configured to separate a utensil from a stack of utensils.

11. A method for dispensing cutlery from a dispenser, the method comprising:
providing a dispenser for dispensing cutlery;
providing a plurality of utensils for dispensing, the utensils adapted to be positioned within the dispenser;
indexing at least two indexing members such that a utensil can be separated from a stack of utensils, the at least two indexing members comprising rotors configured to separate the utensil from a stack of utensils via rotation of the rotors; and
providing access to the utensil separated from the stack of utensils.

12. The method of claim 11, wherein providing a plurality of utensils comprises providing a plurality of separably coupled utensils.

13. The method of claim 11, wherein indexing at least two indexing members comprises:
rotating at least two indexing members in a first direction from an initial orientation such that a utensil is separated from a stack of utensils; and
rotating at least two indexing members in a second direction to return at least two indexing members to the initial orientation.

14. The method of claim 13, wherein rotating at least two of the at least two indexing members in the second direction is facilitated by at least one spring.

15. The method of claim 11, wherein indexing the at least two indexing members is facilitated by activating an actuator operably coupled to the at least two indexing members.

16. The method of claim 11, wherein providing access to the utensil comprises providing a receptacle positioned to receive the utensil separated from the stack of utensils.

17. A method for dispensing cutlery from a dispenser, the method comprising:
providing a dispenser for dispensing cutlery, the dispenser including a plurality of linked members;
providing a plurality of utensils for dispensing, the utensils adapted to be positioned within the dispenser;
manipulating at least one of the plurality of linked members such that one of the plurality of utensils is separated from a stack of utensils; and
providing access to the utensil separated from the stack of utensils.

18. The method of claim 17, wherein at least one of the plurality of linked members comprise a plurality of rotatably-linked members.

19. The method of claim 17, wherein manipulating at least one of the plurality of linked members comprises providing a separating force to at least one utensil and a retaining force to at least one other utensil.

20. The method of claim 17, wherein manipulating at least one of the plurality of linked members comprises rotating at least one member about a joint coupling one linked member to another rotatably-linked member.

21. The method of claim 17, wherein manipulating at least one of the plurality of linked members is facilitated by activating an actuator operably coupled to the linked members.
